(19) United States
(12) Patent Application Publication
(10) Pub. No.: US 2020/0042386 A1
(43) Pub. Date: Feb. 6, 2020

(54) Error Correction With Scatter-Gather List Data Management

(71) Applicant: Burlywood, Inc., Longmont, CO (US)

(72) Inventor: David Christopher Pruett, Longmont, CO (US)

(73) Assignee: Burlywood, Inc., Longmont, CO (US)

(21) Appl. No.: 16/530,492

(22) Filed: Aug. 2, 2019

Related U.S. Application Data
(60) Provisional application No. 62/713,963, filed on Aug. 2, 2018.

(51) Int. Cl. G06F 11/10; G06F 3/06

(52) U.S. Cl. CPC G06F 11/1076; G06F 3/0689; G06F 3/0688; G06F 3/0658; G06F 3/0619; G06F 3/064; G06F 3/0652; G06F 3/0653

(57) ABSTRACT

A storage controller for a storage system is provided. The storage system includes a host interface, a storage interface, a buffer coupled with the host interface and the storage interface, a storage encoder coupled with the buffer, and a storage decoder coupled with the buffer. The storage encoder and storage decoder are configured to use scatter-gather lists in reading data streams from the buffer, and storing data streams to the buffer. They are also configured to provide error correction coding and decoding, with the ability to generate data blocks for missing data blocks.

### RELATED APPLICATIONS

This application hereby claims the benefit of and priority to U.S. Provisional Patent Application No. 62/713,963, titled “ERROR CORRECTION WITH SCATTER GATHER LIST DATA MANAGEMENT”, filed on Aug. 2, 2018 and which is hereby incorporated by reference in its entirety.

### TECHNICAL FIELD

Aspects of the disclosure are related to data storage and in particular to the use of scatter-gather lists in data storage systems.

### TECHNICAL BACKGROUND

Large data storage systems for computers often comprise arrays of memory devices, such as flash memory devices. In order to detect and correct errors occurring during the storage and retrieval of data in the memory devices, various techniques are used including the use of parity bits, Error Correction Codes (ECC), Redundant Array of Independent Disks (RAID), and the like. Often these techniques are used together to protect important data.

During use these large storage systems generate large amounts of data used to manage reads, writes, encoding, and decoding operations within the memory devices. This overhead data is often stored in a buffer within one or more memory controllers. Storing the overhead data in a linear fashion is quick and easy, but wasteful of the buffer memory space, since during encoding and decoding operations hundreds of elements may be involved. In order to keep costs down, buffer memory is designed to be as small as possible, yet meet the needs of the memory controller. Efficient methods of storage of data within the buffer memory is key to reducing buffer memory size.

### OVERVIEW

In an embodiment, a storage controller for a storage system is provided. The storage controller includes a host interface, configured to receive data for storage within the storage system, and to transmit data from the storage system to a host system, a storage interface, configured to transmit data to the storage system, and to receive data from the storage system, a buffer coupled with the host interface and the storage interface, configured to store data and scatter-gather lists, a storage encoder coupled with the buffer, and a storage decoder coupled with the buffer.

The storage encoder is configured to establish encoding tracking data structures indicating scatter-gather lists that correspond to payload data, comprising payload data blocks, and parity data, comprising parity data blocks, scattered over storage locations in the buffer. The storage encoder is further configured to gather target payload data, the target payload data retrieved from the buffer based at least on the encoding tracking data structures, and to encode the target payload data with a selected error correction code to produce target parity data.

The storage encoder is also configured to scatter the target parity data into the buffer, and to update the encoding tracking data structures with locations of the target parity data. The storage decoder is configured to establish decoding tracking data structures indicating scatter-gather lists that correspond to encoded data scattered over storage locations in the buffer, and to identify uncorrectable error locations encountered during decode operations for target encoded data retrieved from the storage system.

The storage decoder is further configured to gather from the buffer further encoded data for regeneration of the target encoded data at uncorrectable error locations, wherein locations of the further encoded data in the buffer are maintained by the decoding tracking data structures, and to determine regenerated data that recreates the target encoded data at the uncorrectable error locations using at least a portion of the further encoded data. The storage decoder is also configured to scatter the regenerated data in the buffer, and to update the tracking data structures with locations of the regenerated data.

In another embodiment, a encoder for a data storage device is provided. The encoder includes a scatter-gather list entity configured to establish tracking data structures indicating scatter-gather lists that correspond to payload data, comprising payload data blocks, and parity data, comprising parity data blocks, scattered over storage locations in a buffer, and a read entity configured to gather target payload data for an encoder entity, the target payload data retrieved from the buffer based at least on the tracking data structures.

The encoder entity is configured to encode the target payload data with a selected error correction code to produce target parity data. The encoder also comprises a write entity configured to scatter the target parity data into the buffer, and update the tracking data structures with locations of the target parity data.

In a further embodiment, a decoder for a data storage device is provided. The decoder includes a scatter-gather list entity configured to establish tracking data structures indicating scatter-gather lists that correspond to encoded data scattered over storage locations in a buffer, and an error handler configured to identify uncorrectable error locations encountered during decode operations for target encoded data retrieved from a storage media.

The decoder further includes a read entity configured to gather from the buffer further encoded data for regeneration of the target encoded data at the uncorrectable error locations, wherein locations of the further encoded data in the buffer are maintained by the tracking data structures. The decoder also includes a decoder entity configured to determine regenerated data that recreates the target encoded data at the uncorrectable error locations using at least a portion of the further encoded data, and a write entity configured to scatter the regenerated data in the buffer, and update the tracking data structures with locations of the regenerated data.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computer host and data storage system.

FIG. 2 illustrates a data storage system.

FIG. 3 illustrates an example of inner and outer codewords in a data storage system.

FIG. 4 illustrates an example of physical assignment of codewords in a data storage system.

FIG. 5 illustrates an example of erasure correction in a data storage system.

FIG. 6 illustrates an example of higher order erasure codes in a data storage system.

FIG. 7 illustrates example scatter-gather lists for use in a storage controller.

FIG. 8 illustrates example scatter-gather lists for use in a storage controller.

FIG. 9 illustrates an example scatter-gather list enabled encoder in a storage controller.

FIG. 10 illustrates an example scatter-gather list enabled decoder in a storage controller.

FIG. 11A illustrates an example method for operating a scatter-gather list enabled encoder in a storage controller.

FIG. 11B illustrates an example method for operating a scatter-gather list enabled decoder in a storage controller.

FIG. 12 illustrates a storage controller.

### DETAILED DESCRIPTION

The examples herein describe the use of scatter gather lists to describe large data structures involved in encoding and decoding erasure codes in data storage systems. Compared to alternatives, this provides a more flexible approach and higher performance by avoiding extra data copy operations and more efficient use of buffer memory.

Scatter-gather lists (SGL) are data structures that define a scatter/gather I/O, where an agent sequentially reads data from multiple buffers and writes it to a single data stream, or reads data from a data stream and writes it to multiple buffers. Also referred to as gather-scatter list.

Concatenated codes are error-correcting codes consisting of individual inner and outer error correction codes. Given two error correction codes F(x) and G(x), where F(x) is the inner code and G(x) is the outer code, a concatenated code is encoded y=H(x)=F(G(x)). Decoding proceeds as x=H⁻¹(y)=G⁻²(F⁻¹(y)).

Erasure codes are forward-error-correcting (FEC) codes that correct symbol erasures. That is, the error location is known with the code only computing the error magnitude. Contrast this with an error-correction code that must determine both the location and magnitude of errors.

Erasure coding and decoding, as implemented in data storage systems, involves a large amount of data. Scatter-gather lists discussed herein can provide an efficient method for handling these buffers, which can organize data in a collection of non-contiguous memory buffers. The flexibility is convenient but also allows data to be operated on in-place, avoiding extra, time-consuming copying of data to adhere to a stricter memory organization, such as a linear organization.

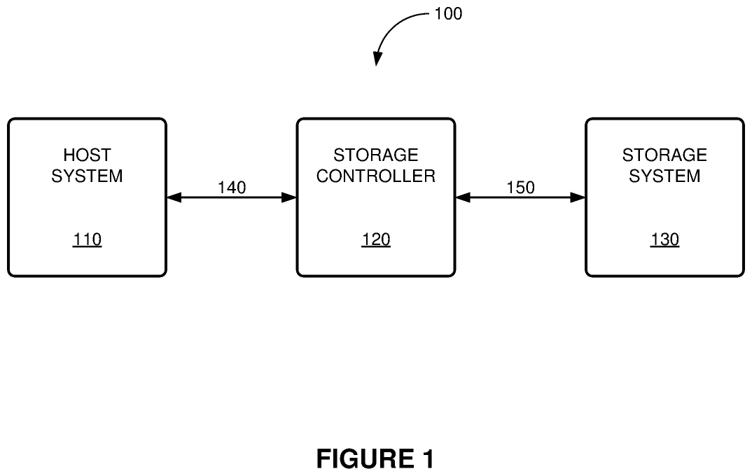

FIG. 1 illustrates computer host system and data storage system 100. In this example embodiment, host system 110 sends data to, and receives data from, storage controller 120 for storage in storage system 130. In an example embodiment, storage system 130 comprises flash non-volatile memory, such as NAND memory. NAND memory is just one example, other embodiments of storage system 130 may comprise other types of storage, including hard disk drives, and the like. Storage controller 120 communicates with storage system over link 150, and performs the function of configuring data received from host system 110 into a format that efficiently uses the memory resources of storage system 130.

In this example, storage controller 120 provides data to storage system 130 by encoding data received from host system 110 to include parity, error correction, and redundancy. Storage controller 120 also provides data to host system 110 by decoding data received from storage system 130, performing error detection and correction. These encoding and decoding processes generate large amounts of working/overhead data which is stored in a buffer within storage controller 120.

As discussed above, storage controller 120 implements error correction code (ECC) encode/decode functions, along with data encoding, data recovery, retry recovery methods, and other processes and methods to optimize data integrity. Storage controller 120 includes the ability to provide multi-level ECC correction over a wide range of data block sizes, allowing for the correction of data errors both large and small.

Storage controller 120 may take any of a variety of configurations. In some examples, storage controller 120 may be a Field Programmable Gate Array (FPGA) with software, software with a memory buffer, an Application Specific Integrated Circuit (ASIC) designed to be included in a single module with storage system 130, a set of Hardware Description Language (HDL) commands, such as Verilog or System Verilog, used to create an ASIC, a separate module from storage system 130, built in to storage system 130, or any of many other possible configurations.

Host system 110 communicates with storage controller 120 over various communication links, such as communication link 140. These communication links may use the Internet or other global communication networks. Each communication link may comprise one or more wireless links that can each further include Long Term Evolution (LTE), Global System For Mobile Communications (GSM), Code Division Multiple Access (CDMA), IEEE 802.11 WiFi, Bluetooth, Personal Area Networks (PANs), Wide Area Networks, (WANs), Local Area Networks (LANs), or Wireless Local Area Networks (WLANs), including combinations, variations, and improvements thereof. These communication links can carry any communication protocol suitable for wireless communications, such as Internet Protocol (IP) or Ethernet.

Additionally, communication links can include one or more wired portions which can comprise synchronous optical networking (SONET), hybrid fiber-coax (HFC), Time Division Multiplex (TDM), asynchronous transfer mode (ATM), circuit-switched, communication signaling, or some other communication signaling, including combinations, variations or improvements thereof. Communication links can each use metal, glass, optical, air, space, or some other material as the transport media. Communication links may each be a direct link, or may include intermediate networks, systems, or devices, and may include a logical network link transported over multiple physical links.

Storage controller 120 communicates with storage system 130 over link 150. Link 150 may be any interface to a storage device or array. In one example, storage system 130 comprises NAND flash memory and link 150 may use the Open NAND Flash Interface (ONFI) command protocol, or the “Toggle” command protocol to communicate between storage controller 120 and storage system 130. Other embodiments may use other types of memory and other command protocols. Other common low level storage interfaces include DRAM memory bus, SRAM memory bus, and SPI.

Link 150 can also be a higher level storage interface such as SAS, SATA, PCIe, Ethernet, Fiber Channel, Infiniband, and the like. However—in these cases, storage controller 120 would reside in storage system 130 as it has its own controller.

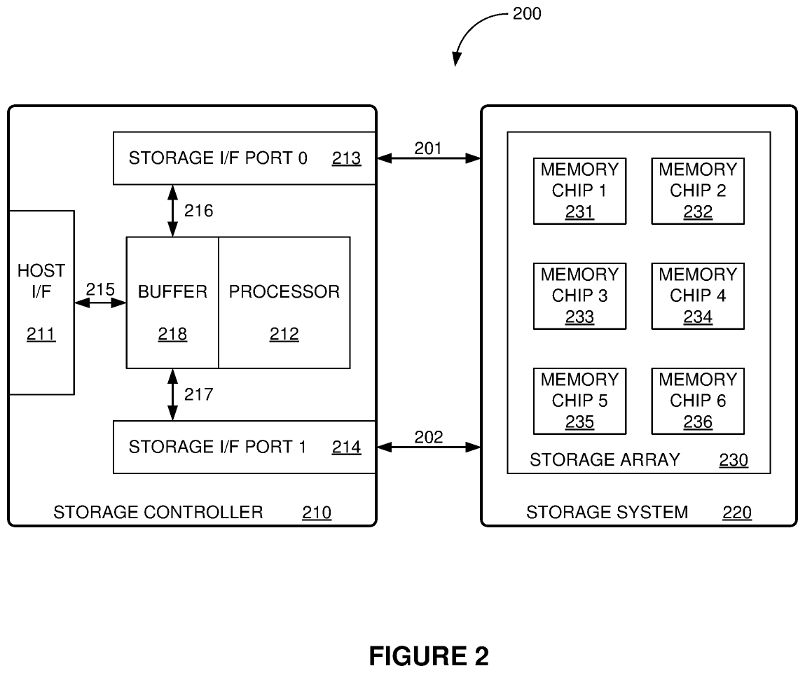

FIG. 2 illustrates data storage system 200. This example system comprises storage controller 210 and storage system 220. Storage system 220, comprises storage array 230. Storage array 230 comprises memory chips 1-6 (231-236). In an example embodiment, each memory chip 231-236 is a NAND memory integrated circuit. Other embodiments may use other types of memory.

Storage controller 210 comprises a number of blocks or modules including host interface 211, processor 212, buffer 218, storage interface port 0 213, and storage interface port 1 214. Processor 212 and buffer 218 communicate with the other blocks over links 215, 216, and 217. Storage interface port 0 213 communicates with storage system 220 over link 201 and storage interface port 1 214 communicates with storage system 220 over link 202.

In some example embodiments, storage interface ports 0 and 1 (213 and 214) may use the Open NAND Flash Interface (ONFI) command protocol, or the “Toggle” command protocol to communicate with storage system 220 over links 201 and 201. The ONFI specification includes both the physical interface and the command protocol of ONFI ports 0 and 1. The interface includes an 8-bit bus (in links 201 and 202) and enables storage controller 210 to perform read, program, erase, and other associated operations to operate memory chips 1-6 (231-236) within storage array 230.

Multiple memory chips may share each ONFI bus, however individual memory chips may not share multiple ONFI buses. Chips on one bus may only communicate with that bus. For example, memory chips 1-3 (231-233) may reside on bus 201, and memory chips 4-6 (234-236) may reside on bus 202.

In this example, processor 212 receives host data from a host through host I/O interface 211 over link 215. Processor 212 configures the data as needed for storage in storage system 220 and transfers the data to storage interface ports 0 and 1 (213 and 214) for transfer to storage system 220 over links 201 and 202.

As illustrated, storage array 230 comprises a plurality of memory chips 231-236, these memory chips may be configured to provide redundancy, or multiple storage arrays may be used to provide redundancy. While flash memory chips are illustrated here, any other memory device including hard drives may be used within the scope of the present invention.

As a background, consider the case of encoding and decoding erasure codes for a data storage system. An example would be RAID-5 or RAID-6 in a data storage system composed of discrete hard drives or solid-state drives (SSD) that protects against drive failures in the system. Some SSDs employ a similar system across individual non-volatile memory devices.

Erasure codes are often an outer code of a concatenated code. The code may be simple parity (RAID-5), double parity (RAID-6), or other codes, such as Reed Solomon, for correcting more than one erasure. Detection of failed correction in the inner code provide erasure pointers for the outer code.

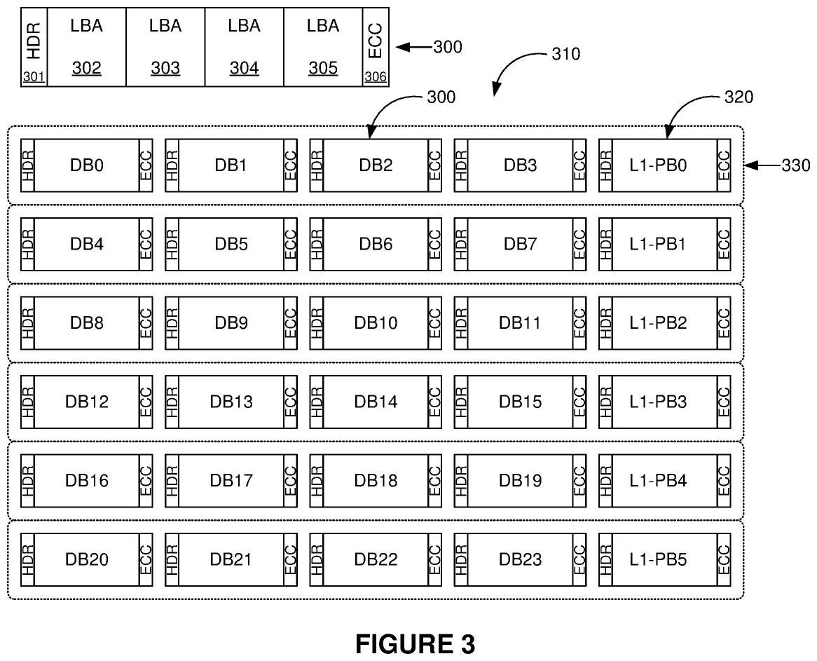

FIG. 3 illustrates an example of inner 300 and outer 320 codewords in a data storage system, such as storage system 220 from FIG. 2. As an example of an inner codeword, the payload of inner codeword 300 includes header (HDR) 301, four logical blocks 302-305 having logical block addresses (LBA), and error correction coding (ECC) data 306 for the inner code. This inner codeword 300 could correspond to a physical block in a hard drive or a flash page in an SSD. During most operations, the inner code suffices to correct any errors in the codeword. In the unlikely event there are too many errors, the failures present an erasure pointer to the outer, erasure code.

A number of these inner codewords 300 are encoded to form outer codewords 320, producing parity blocks of the same size as the data blocks. In this example, four inner codewords 300 are encoded to form each outer codeword 320, and the five codewords form a row 330 of payloads. The outer codeword 320 is also encoded with the inner code, producing a header (HDR) and error correction coding (ECC) included in the payload of outer codeword 320 for writing to the storage system.

In this example, data blocks DB0-DB3 are encoded to produce L1-PB0 (level 1 parity block 0) which together form one row 330 of payloads. Likewise, data blocks DB4-DB7 are encoded to produce L1-PB1, data blocks DB8-DB11 are encoded to produce L1-PB2, data blocks DB12-DB15 are encoded to produce L1-PB3, data blocks DB16-DB19 are encoded to produce L1-PB4, and data blocks DB20-DB23 are encoded to produce L1-PB5.

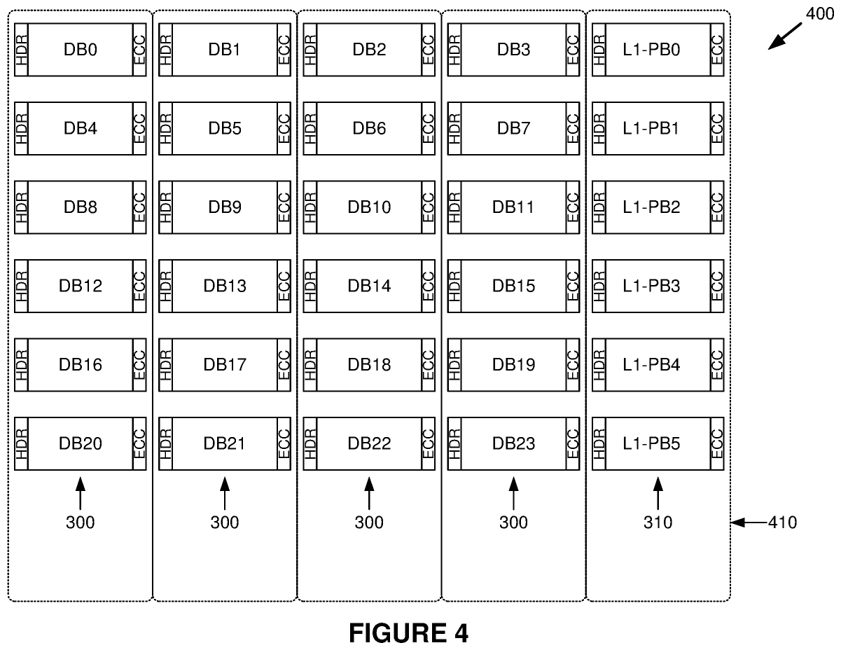

FIG. 4 illustrates an example of physical assignment of codewords 400 in a data storage system, such as storage system 220 from FIG. 2. In this example, the data structure of inner 300 and outer 320 codewords illustrated in FIG. 3 is divided into columns 410 for storage in storage system 220. Each column may correspond to different physical elements in storage system 220, such as drives in a RAID-5 configuration or flash memory chips 231-236 in a solid-state drive (SSD).

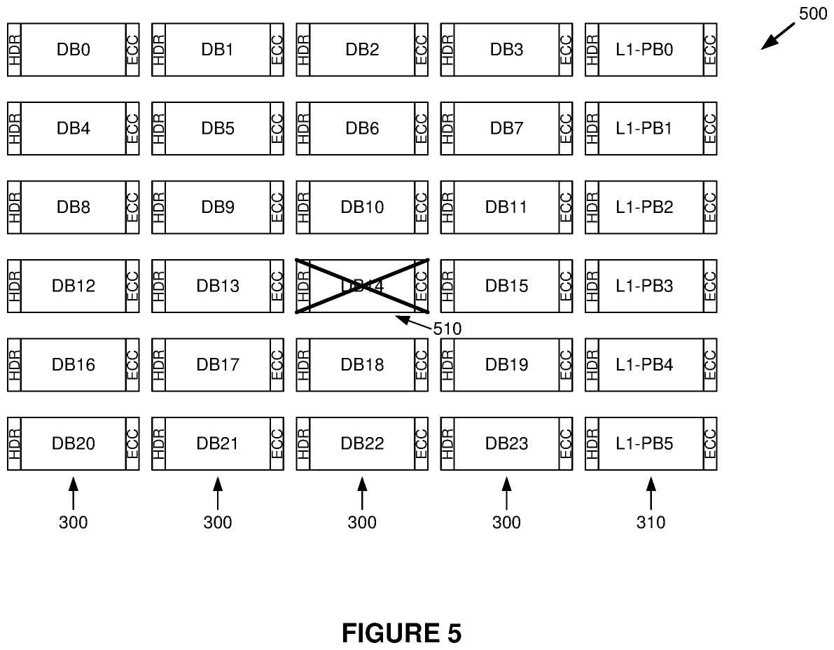

FIG. 5 illustrates an example of erasure correction in a data storage system 500, such as storage system 220 from FIG. 2. In this example, a data block (DB14) 510 contains too many errors for the inner code to handle. After failing to recover DB14 510 with the inner code, DB14 is considered an erasure or lost data and the other blocks of the containing outer codeword (DB12, DB13, DB15, and L1-PB3) are responsively read. The outer codeword is decoded using a combination of DB12, DB13, DB15, and L1-PB3, thus restoring DB14.

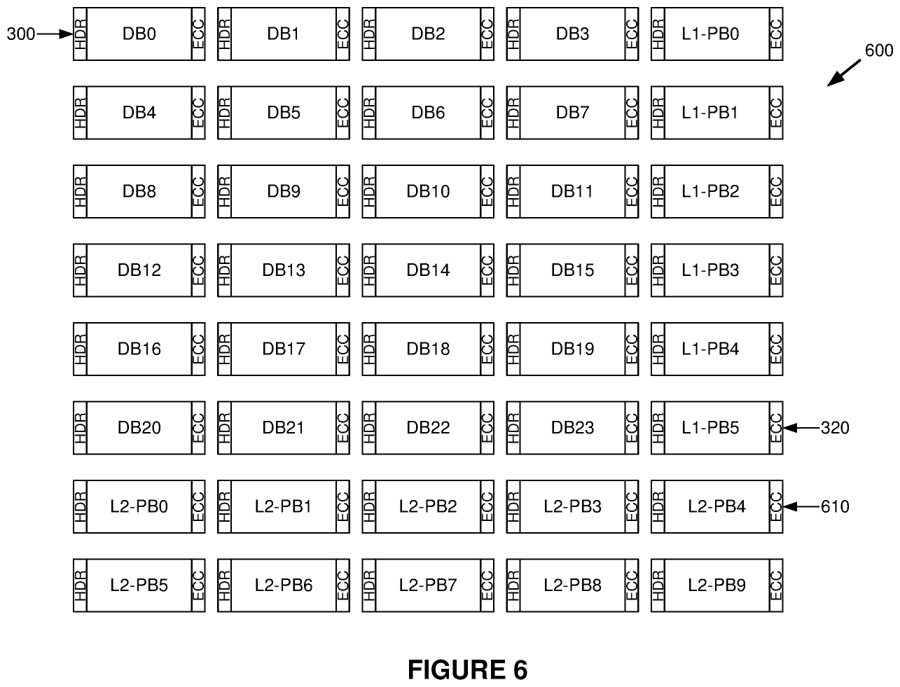

FIG. 6 illustrates an example of higher order erasure codes in a data storage system 600. In this embodiment, two nested levels of erasure coding are illustrated, with the addition of level 2 codewords 610. Here, in addition to the six outer codewords 310 from FIG. 3 an additional ten outer codewords L2-PB0-L2-PB9 are generated from the inner 300 and outer 320 codewords. These additional outer codewords 610 include headers (HDR) and error correction (ECC) in their payloads. While this example embodiment shows ten outer codewords, the level 2 outer codewords may be implemented in any of a wide variety of ways. For example, some embodiments may have one very large level 2 codeword capable of ten erasures, while other embodiments may have five smaller level 2 codewords each capable of two erasures, all within the scope of the present invention.

Encoding and decoding operations involve manipulating large numbers of elements to compose all of the data and parity blocks of the outer codeword. Each outer codeword (L1-PBx or L2-PBx) consists of a number of data blocks, possibly hundreds, and one or more parity blocks. Each data block (DBx) is composed of a header and a number of logical blocks. Thus, to encode an outer codeword several hundreds of elements may be involved.

While these elements could be laid out linearly in buffer memory, that is often incompatible with a system memory management sub-system. Instead, a data structure called a scatter-gather list (SGL) is presented herein to describe each data and parity block without any requirement on the location of the individual elements in buffer memory.

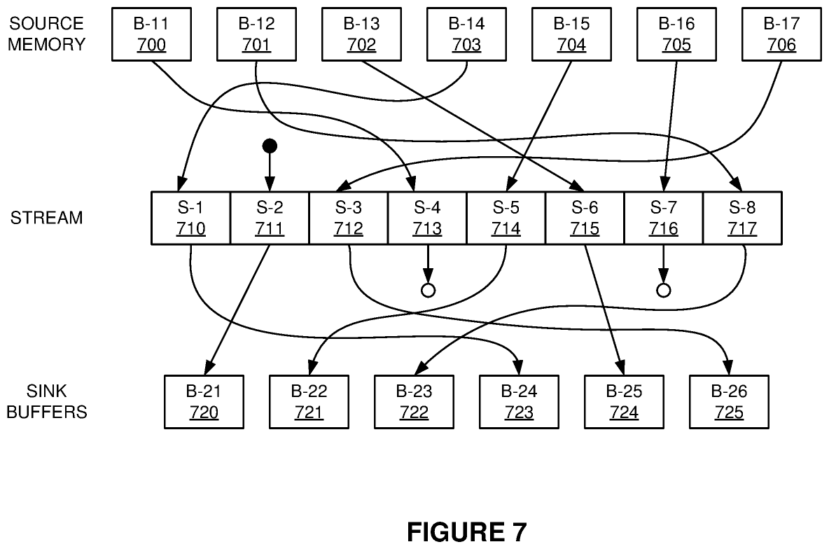

FIG. 7 illustrates example scatter-gather lists for use in a storage controller. FIG. 7 shows two example scatter-gather-lists relating a number of buffers to and from a data stream. The buffers need not have any relationship to each other until combined by a source SGL entity into a stream. Additionally, a source SGL entity may actually fabricate pattern data that need not reside in any buffer—possibly for pad or fill data. Similarly, a sink SGL entity may split a stream into arbitrary buffers, possibly even discarding some portion of the stream. This gives great flexibility when managing the numerous elements in an encoding/decoding operation.

In this example, source memory buffers B-11-B-17 700-706 contain data to be merged to create data stream S-1-S-8 710-717. This data stream S-1-S-8 710-717 is then stored in to sink buffer locations B-21-B-26 720-725. within the buffer memory.

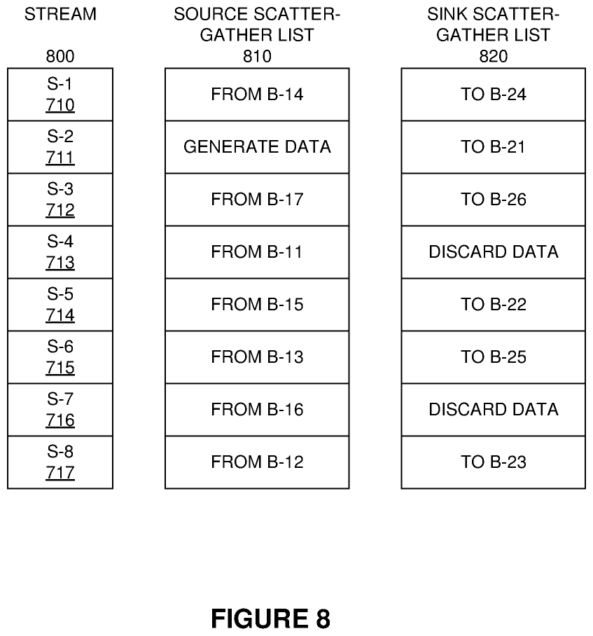

FIG. 8 illustrates example scatter-gather lists for use in a storage controller. In this example, two scatter-gather lists corresponding to the operations illustrated in FIG. 7 are illustrated. Data stream 800 includes data blocks S-1-S-8 710-717. Each data block corresponds to an entry in each of the two scatter-gather lists illustrated: source scatter-gather list 810, and sink scatter-gather list 820. In this example, stream data block S-1 710 receives data from source memory block B-14 703 as directed by source scatter-gather list 810 and then transfers the data to sink buffer B-24 723 as directed by sink scatter-gather list 820.

Likewise, stream data block S-2 711 generates data as directed by source scatter-gather list 810 and then transfers the data to sink buffer B-21 720 as directed by sink scatter-gather list 820. Stream data block S-3 712 receives data from source memory block B-17 706 as directed by source scatter-gather list 810 and then transfers the data to sink buffer B-26 725 as directed by sink scatter-gather list 820. Stream data block S-4 713 receives data from source memory block B-11 700 as directed by source scatter-gather list 810 and then discards the data as directed by sink scatter-gather list 820.

Stream data block S-5 714 receives data from source memory block B-15 704 as directed by source scatter-gather list 810 and then transfers the data to sink buffer B-22 721 as directed by sink scatter-gather list 820. Stream data block S-6 715 receives data from source memory block B-13 702 as directed by source scatter-gather list 810 and then transfers the data to sink buffer B-25 724 as directed by sink scatter-gather list 820. Stream data block S-7 716 receives data from source memory block B-16 705 as directed by source scatter-gather list 810 and then discards the data as directed by sink scatter-gather list 820. Stream data block S-8 717 receives data from source memory block B-12 701 as directed by source scatter-gather list 810 and then transfers the data to sink buffer B-23 722 as directed by sink scatter-gather list 820.

While this example embodiment illustrated in FIG. 8 shows rows in data stream 800, source scatter-gather list 810, and sink scatter-gather list 820 corresponding with each other on a one-to-one basis, keep in mind that this example illustrates just one possible correlation. The only requirement is that the number of bytes in data stream 800, source scatter-gather list 810, and sink scatter-gather list 820 must match, but rows in source scatter-gather list 810 and sink scatter-gather list 820 may correspond to different numbers of bytes in data stream 800. Source scatter-gather list 810, and sink scatter-gather list 820 do not need to even have the same number of rows within the scope of the present invention.

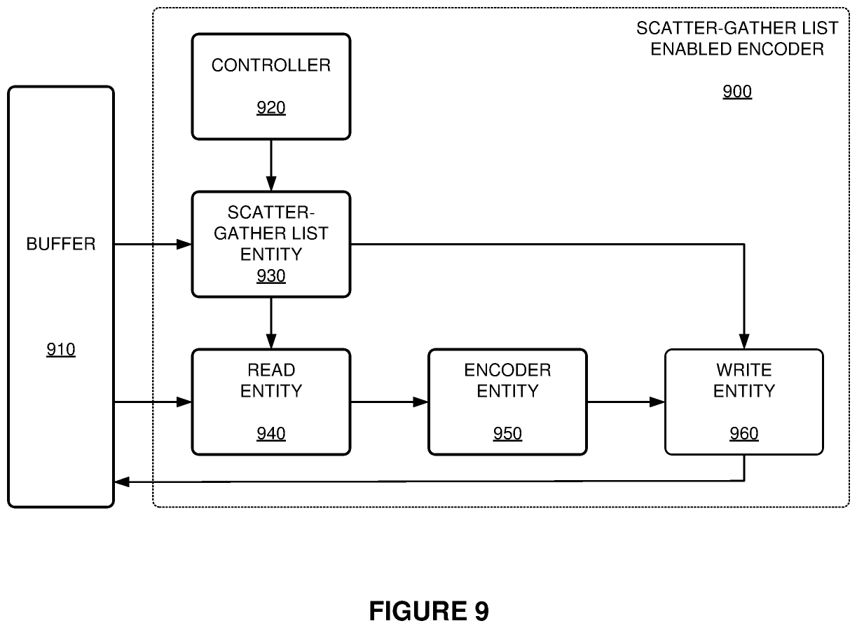

FIG. 9 illustrates an example scatter-gather list enabled encoder 900 in a storage controller, such as storage controller 120 from FIG. 1. In this example embodiment, scatter-gather list enabled encoder 900 utilizes scatter-gather lists to describe the data and parity blocks that comprise a codeword. Controller 920 configures the other components, starts the operation, and monitors its progress.

Scatter-gather list entity 930 loads scatter-gather lists from buffer 910 and forms one or more scatter-gather list tables (such as those illustrated in FIG. 8) as tracking data structures. In an example embodiment, there is one source SGL for each data block and one sink SGL for each parity block. Scatter-gather list entity 930 provides these to read entity 940 and write entity 960 during the encoding operation.

Read entity 940, using the SGLs from the one or more tables formed by scatter-gather list entity 930 as a guide, reads or generates data streams for each data block and provides them to encoder entity 950.

Encoder entity 950 receives stream data from read entity 940, encodes it with the appropriate ECC code, and produces streams of parity data for each parity block to write entity 960.

Write entity 960 receives streams of parity data from encoder entity 950 and, using the one or more tables formed by scatter-gather list entity 930 as a guide, writes data to buffer 910.

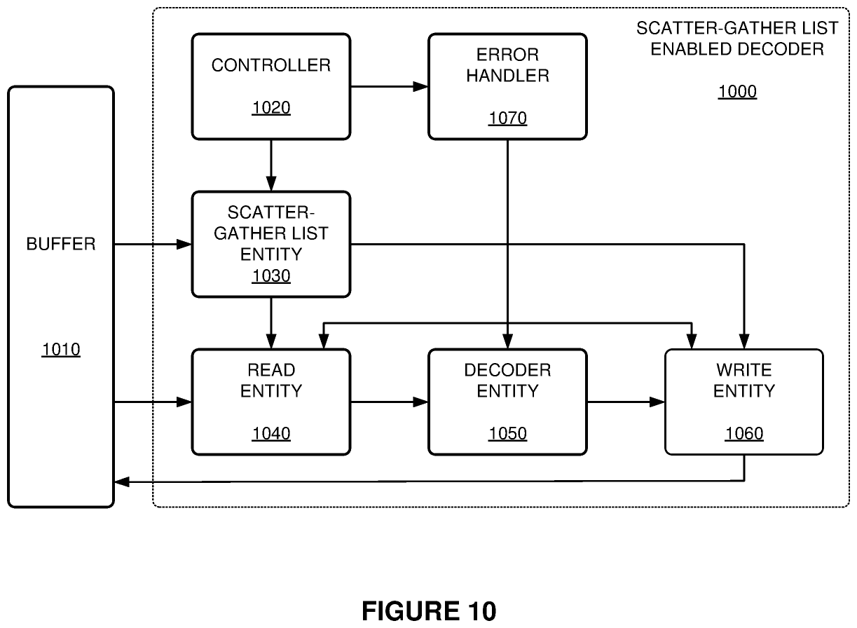

FIG. 10 illustrates an example scatter-gather list enabled decoder 1000 in a storage controller, such as storage controller 120 from FIG. 1. In this example embodiment, scatter-gather list enabled decoder 1000 utilizes scatter-gather lists to describe the data and parity blocks comprising a codeword.

Controller 1020 configures the other components, starts the operation, and monitors its progress. Scatter-gather list entity 1030 loads scatter-gather lists from buffer 1010 and forms one or more SGL tables. In an example embodiment, there is one SGL for each data and parity block. Un-erased blocks use a source SGL, while erased blocks use a sink SGL. Scatter-gather list entity 1030 provides these tables to read entity 1040 and write entity 1060 during the decoding operation.

The error handler 1070, having been informed of the locations of missing data or parity blocks by controller 1020, informs the other components of these locations so that the other components can coordinate the decoding operation.

Read entity 1040, using erasure pointers and SGLs from the one or more tables of scatter-gather list entity 1030 as guides, reads data streams for each un-erased data or parity block and provides them to decoder entity 1050.

Decoder entity 1050 receives erasure pointers and stream data from read entity 1040, decodes it with the appropriate ECC code, and regenerates a stream for each erased block to write entity 1060.

Write entity 1060 receives erasure pointers and streams of recovered data from decoder entity 1050 and, using the SGLs from the one or more tables of the scatter-gather list entity 1030 as a guide, writes data to buffer 1010.

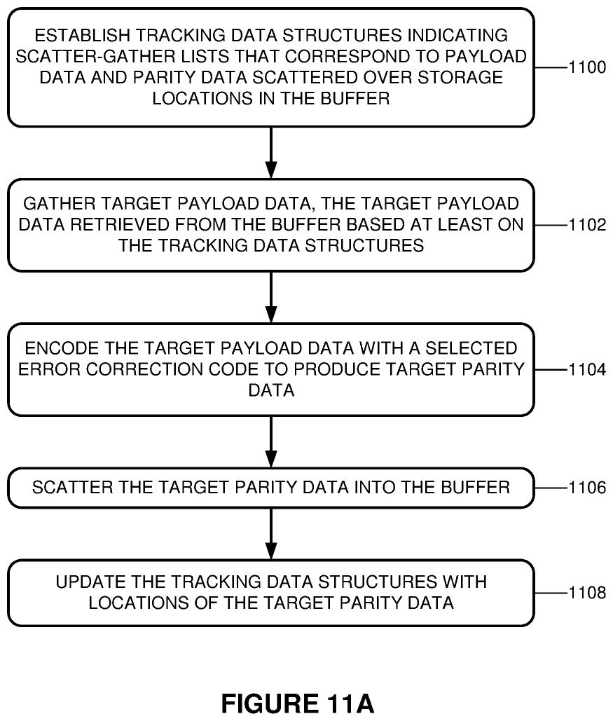

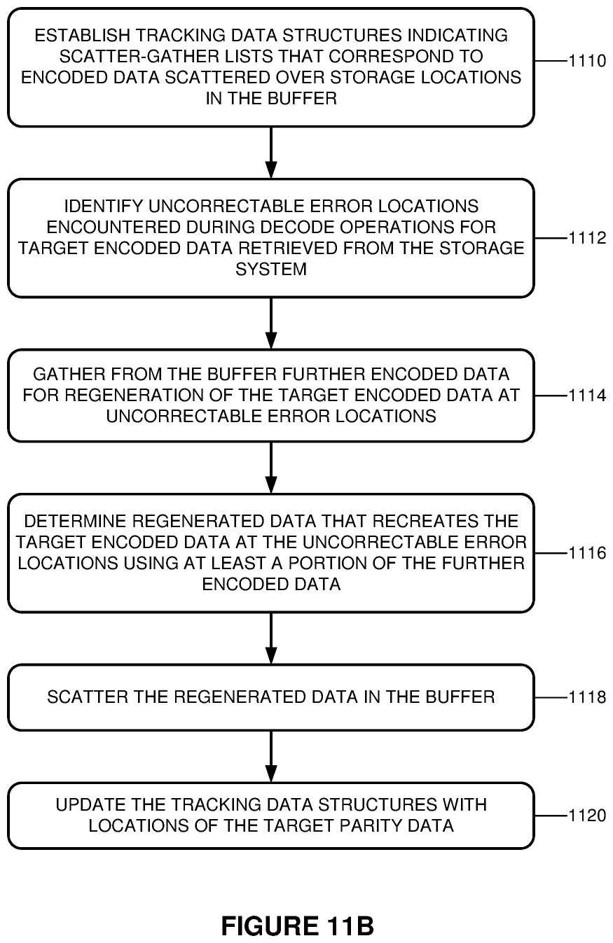

FIG. 11A illustrates an example method for operating a scatter-gather list enabled encoder 900, in a storage controller 120. In this example method, scatter-gather list enabled encoder 900 establishes tracking data structures indicating scatter-gather lists that correspond to payload data and parity data scattered over storage locations in the buffer 910, (operation 1100).

Scatter-gather list enabled encoder 900 gathers target payload data, the target payload data retrieved from the buffer 910 based at least on the tracking data structures, (operation 1102). Scatter-gather list enabled encoder 900 encodes the target payload data with a selected error correction code to produce target parity data, (operation 1104).

Scatter-gather list enabled encoder 900 scatters the target parity data into the buffer 910, (operation 1106), and updates the tracking data structures with locations of the target parity data, (operation 1108).

FIG. 11B illustrates an example method for operating a scatter-gather list enabled decoder 1000 in a storage controller. In this example method, scatter-gather list enabled decoder 1000 establishes tracking data structures indicating scatter-gather lists that correspond to encoded data scattered over storage locations in the buffer 1010, (operation 1110).

Scatter-gather list enabled decoder 1000 identifies uncorrectable error locations encountered during decode operations for target encoded data retrieved from the storage system, (operation 1112). Scatter-gather list enabled decoder 1000 gathers from the buffer 1010 further encoded data for regeneration of the target encoded data at uncorrectable error locations, wherein locations of the further encoded data in the buffer are maintained by the tracking data structures, (operation 1114).

Scatter-gather list enabled decoder 1000 determines regenerated data that recreates the target encoded data at the uncorrectable error locations using at least a portion of the further encoded data, (operation 1116). Scatter-gather list enabled decoder 1000 scatters the regenerated data in the buffer 1010, (operation 1118), and updates the tracking data structures with locations of the regenerated data, (operation 1120).

In summary, without a per-symbol scatter-gather list, data for the encoding/decoding operation must be organized in a more predictable manner.

The least flexible solution is a single large, statically-allocated, possibly contiguous buffer. This may comprise memory dedicated to the encoder/decoder hardware. Data for each symbol must copied into this dedicated memory. This is more straightforward for the hardware to handle as data is read from and written to predictable addresses.

Another alternative is a per-codeword SGL. That is, the data for each symbol may be at any location in memory but each symbol must consist of a single, contiguous buffer. This provides somewhat more flexibility, with only minimally more complex hardware, but still places restrictions on the data organization that may impose restrictions on the rest of the system or require data copying.

In data storage systems, using scatter-gather-lists to describe data involved in outer erasure encoding/decoding operations can enable greater flexibility in defining memory buffers involved in these operations.

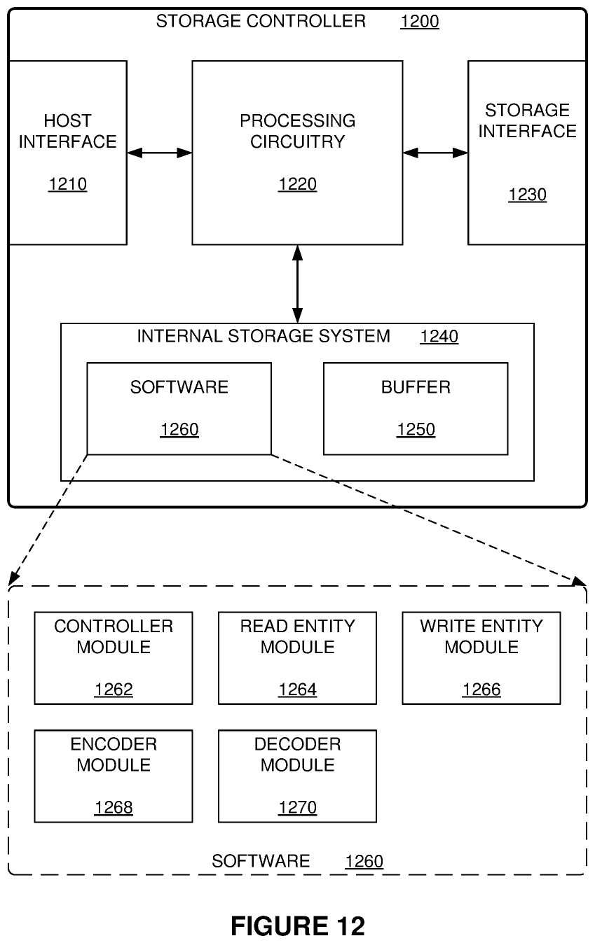

FIG. 12 illustrates storage controller 1200. As discussed above, storage controller 1200 may take on any of a wide variety of configurations. Here, an example configuration is provided for a storage controller implemented as an ASIC. However, in other examples, storage controller 1200 may be built into a storage system or storage array, or into a host system.

In this example embodiment, storage controller 1200 comprises host interface 1210, processing circuitry 1220, storage interface 1230, and internal storage system 1240. Host interface 1210 comprises circuitry configured to receive data and commands from an external host system and to send data to the host system.

Storage interface 1230 comprises circuitry configured to send data and commands to an external storage system and to receive data from the storage system. In some embodiments storage interface 1230 may include ONFI ports for communicating with the storage system.

Processing circuitry 1220 comprises electronic circuitry configured to perform the tasks of a storage controller utilizing scatter-gather lists as described above. Processing circuitry 1220 may comprise microprocessors and other circuitry that retrieves and executes software 1260. Processing circuitry 1220 may be embedded in a storage system in some embodiments. Examples of processing circuitry 1220 include general purpose central processing units, application specific processors, and logic devices, as well as any other type of processing device, combinations, or variations thereof. Processing circuitry 1220 can be implemented within a single processing device but can also be distributed across multiple processing devices or sub-systems that cooperate in executing program instructions.

Internal storage system 1240 can comprise any non-transitory computer readable storage media capable of storing software 1260 that is executable by processing circuitry 1220. Internal storage system 1220 can also include various data structures which comprise one or more databases, tables, lists, or other data structures. In this example, internal storage system 1220 includes buffer 1250, which corresponds to buffer 910 of FIG. 9 and buffer 1010 of FIG. 10. Storage system 1240 can include volatile and nonvolatile, removable and non-removable media implemented in any method or technology for storage of information, such as computer readable instructions, data structures, program modules, or other data.

Storage system 1240 can be implemented as a single storage device but can also be implemented across multiple storage devices or sub-systems co-located or distributed relative to each other. Storage system 1240 can comprise additional elements, such as a controller, capable of communicating with processing circuitry 1220. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof.

Software 1260 can be implemented in program instructions and among other functions can, when executed by storage controller 1200 in general or processing circuitry 1220 in particular, direct storage controller 1200, or processing circuitry 1220, to operate as described herein for a storage controller. Software 1260 can include additional processes, programs, or components, such as operating system software, database software, or application software. Software 1260 can also comprise firmware or some other form of machine-readable processing instructions executable by elements of processing circuitry 1220.

In at least one implementation, the program instructions can include controller module 1262, read entity module 1264, write entity module 1266, encoder module 1268, and decoder module 1270.

Controller module 1262 includes instructions directing processing circuitry 1220 to operate as controller module 920 from FIG. 9 and/or controller module 1020 from FIG. 10. Read entity module 1264 includes instructions directing processing circuitry 1220 to operate as read entity 940 from FIG. 9 and/or read entity 1040 from FIG. 10. Write entity module 1266 includes instructions directing processing circuitry 1220 to operate as write entity 960 from FIG. 9 and/or write entity 1060 from FIG. 10.

Encoder module 1268 includes instructions directing processing circuitry 1220 to operate as encoder entity 950 from FIG. 9. Decoder module 1270 includes instructions directing processing circuitry 1220 to operate as decoder entity 1050 from FIG. 10.

In general, software 1260 can, when loaded into processing circuitry 1220 and executed, transform processing circuitry 1220 overall from a general-purpose computing system into a special-purpose computing system customized to operate as described herein for a storage controller, among other operations. Encoding software 1260 on internal storage system 1240 can transform the physical structure of internal storage system 1240. The specific transformation of the physical structure can depend on various factors in different implementations of this description. Examples of such factors can include, but are not limited to the technology used to implement the storage media of internal storage system 1240 and whether the computer-storage media are characterized as primary or secondary storage.

For example, if the computer-storage media are implemented as semiconductor-based memory, software 1260 can transform the physical state of the semiconductor memory when the program is encoded therein. For example, software 1260 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above may be combined in various ways to form multiple embodiments. As a result, the invention is not limited to the specific embodiments described above, but only by the claims and their equivalents.

What is claimed is:

1. A storage controller for a storage system, comprising:
a host interface, configured to receive data for storage within the storage system, and to transmit data from the storage system to a host system;
a storage interface, configured to transmit data to the storage system, and to receive data from the storage system;
a buffer coupled with the host interface and the storage interface, configured to store data and scatter-gather lists;
a storage encoder coupled with the buffer and configured to:
establish encoding tracking data structures indicating scatter-gather lists that correspond to payload data, comprising payload data blocks, and parity data, comprising parity data blocks, scattered over storage locations in the buffer;
gather target payload data, the target payload data retrieved from the buffer based at least on the encoding tracking data structures;
encode the target payload data with a selected error correction code to produce target parity data;
scatter the target parity data into the buffer; and
update the encoding tracking data structures with locations of the target parity data; and
a storage decoder coupled with the buffer and configured to:
establish decoding tracking data structures indicating scatter-gather lists that correspond to encoded data scattered over storage locations in the buffer;
identify uncorrectable error locations encountered during decode operations for target encoded data retrieved from the storage system;
gather from the buffer further encoded data for regeneration of the target encoded data at uncorrectable error locations, wherein locations of the further encoded data in the buffer are maintained by the decoding tracking data structures;
determine regenerated data that recreates the target encoded data at the uncorrectable error locations using at least a portion of the further encoded data;
scatter the regenerated data in the buffer; and
update the tracking data structures with locations of the regenerated data.

2. The storage controller of claim 1, wherein there is one source scatter-gather list for each payload data block and one sink scatter-gather list for each parity data block.

3. The storage controller of claim 1, wherein the storage encoder is further configured to:
encode the target payload data using a concatenated error correction code.

4. The storage controller of claim 1, wherein the storage encoder is further configured to:
encode the target payload data using two or more nested levels of erasure coding.

5. The storage controller of claim 1, wherein the storage encoder is further configured to:
generate target payload data.

6. The storage controller of claim 1, wherein the storage decoder is further configured to:
discard encoded data as directed by the tracking data structures.

7. The storage controller of claim 1, wherein the storage decoder is further configured to:
determine locations of missing data or parity blocks.

8. The storage controller of claim 1, wherein the storage system comprises flash non-volatile memory.

9. The storage controller of claim 1, wherein the storage system comprises one or more hard disk drives.

10. A encoder for a data storage device, comprising:
a scatter-gather list entity configured to establish tracking data structures indicating scatter-gather lists that correspond to payload data, comprising payload data blocks, and parity data, comprising parity data blocks, scattered over storage locations in a buffer;
a read entity configured to gather target payload data for an encoder entity, the target payload data retrieved from the buffer based at least on the tracking data structures;
the encoder entity configured to encode the target payload data with a selected error correction code to produce target parity data; and
a write entity configured to scatter the target parity data into the buffer, and update the tracking data structures with locations of the target parity data.

11. The encoder of claim 10, wherein there is one source scatter-gather list for each payload data block and one sink scatter-gather list for each parity data block.

12. The encoder of claim 10, further configured to:
encode the target payload data using a concatenated error correction code.

13. The encoder of claim 10, further configured to:
encode the target payload data using two or more nested levels of erasure coding.

14. The encoder of claim 10, further configured to:
generate target payload data.

15. The encoder of claim 11, wherein the data storage device comprises flash non-volatile memory.

16. A decoder for a data storage device, comprising:
a scatter-gather list entity configured to establish tracking data structures indicating scatter-gather lists that correspond to encoded data scattered over storage locations in a buffer;
an error handler configured to identify uncorrectable error locations encountered during decode operations for target encoded data retrieved from a storage media;
a read entity configured to gather from the buffer further encoded data for regeneration of the target encoded data at the uncorrectable error locations, wherein locations of the further encoded data in the buffer are maintained by the tracking data structures;
a decoder entity configured to determine regenerated data that recreates the target encoded data at the uncorrectable error locations using at least a portion of the further encoded data; and
a write entity configured to scatter the regenerated data in the buffer, and update the tracking data structures with locations of the regenerated data.

17. The decoder of claim 16, wherein the storage decoder is further configured to:
discard encoded data as directed by the tracking data structures.

18. The decoder of claim 16, wherein the storage decoder is further configured to:
determine locations of missing data or parity blocks.

19. The decoder of claim 16, wherein the storage system comprises flash non-volatile memory.

20. The decoder of claim 16, wherein the storage system comprises one or more hard disk drives.
